(19) United States
(12) Patent Application Publication
(10) Pub. No.: US 2021/0400316 A1
(43) Pub. Date: Dec. 23, 2021

(54) TRANSMISSION DEVICE, TRANSMISSION METHOD, RECEPTION DEVICE, AND RECEPTION METHOD

(71) Applicant: Sony Group Corporation, Tokyo (JP)

(72) Inventor: Lui SAKAI, Tokyo (JP)

(73) Assignee: Sony Group Corporation, Tokyo (JP)

(21) Appl. No.: 17/290,550

(22) PCT Filed: Nov. 26, 2019
(86) PCT No.: PCT/JP2019/046053

§ 371 Date: Apr. 30, 2021

(30) Foreign Application Priority Data
Dec. 10, 2018 (JP) 2018-230974

(51) Int. Cl. H04N 21/2383; H04L 27/26

(52) U.S. Cl. CPC H04N 21/2383; H04L 27/261; H04L 27/2604

(57) ABSTRACT

The present technology relates to a transmission device, a transmission method, a reception device, and a reception method that make it possible to improve transmission efficiency.

Provided is a transmission device including a first time interleaver that performs first time interleaving conforming to a first system, on an error correction code block to be included as a data frame in a physical layer frame, in which the error correction code block conforms to a second system, and when performing the first time interleaving, the first time interleaver applies a pointer indicating an offset of a start position of the error correction code block included at a start of the data frame. The present technology can be applied to, for example, a transmission system compatible with a broadcast system such as an ISDB-T system.

### TECHNICAL FIELD

The present technology relates to a transmission device, a transmission method, a reception device, and a reception method, and more particularly to a transmission device, a transmission method, a reception device, and a reception method enabled to improve transmission efficiency.

### BACKGROUND ART

For example, in Japan, studies have been conducted on the sophistication of terrestrial digital television broadcasting toward the next generation, and various technical methods have been studied (see, for example, Patent Documents 1 to 3).

### CITATION LIST

### Patent Document

### Patent Document 1: Japanese Patent Application Laid-Open No. 2015-65627

### Patent Document 2: Japanese Patent Application Laid-Open No. 2018-67825

### Patent Document 3: Japanese Patent Application Laid-Open No. 2018-101862

### SUMMARY OF THE INVENTION

### Problems to be Solved by the Invention

By the way, when operation of a next-generation broadcast system is started, a period of transition from a current broadcast system to the next-generation broadcast system is provided, and it is required to improve transmission efficiency even in the period of transition.

The present technology has been made in view of such a situation, and makes it possible to improve the transmission efficiency.

### Solutions to Problems

A transmission device of one aspect of the present technology is a transmission device including a first time interleaver that performs first time interleaving conforming to a first system, on an error correction code block to be included as a data frame in a physical layer frame, in which the error correction code block conforms to a second system, and when performing the first time interleaving, the first time interleaver applies a pointer indicating an offset of a start position of the error correction code block included at a start of the data frame.

The transmission device of one aspect of the present technology may be an independent device or an internal block constituting one device. Furthermore, a transmission method of one aspect of the present technology is a transmission method corresponding to the transmission device of one aspect of the present technology described above.

In the transmission device and the transmission method of one aspect of the present technology, the first time interleaving conforming to the first system is performed on the error correction code block to be included as the data frame in the physical layer frame. Furthermore, the error correction code block conforms to the second system, and when the first time interleaving is performed, the pointer is applied that indicates the offset of the start position of the error correction code block included in the start of the data frame.

A reception device of one aspect of the present technology is a reception device including a first time deinterleaver that performs first time deinterleaving in which an error correction code block after first time interleaving extracted from a physical layer frame transmitted from a transmission device is returned to be in original temporal order depending on an offset, the transmission device including a time interleaver that applies a pointer indicating the offset of a start position of the error correction code block included at a start of a data frame when performing the first time interleaving conforming to a first system on the error correction code block conforming to a second system and to be included as a data frame in the physical layer frame.

Note that, the reception device of one aspect of the present technology may be an independent device or an internal block constituting one device. Furthermore, a reception method of one aspect of the present technology is a reception method corresponding to the reception device of one aspect of the present technology described above.

In the reception device and the reception method of one aspect of the present technology, the first time deinterleaving is performed in which the error correction code block after the first time interleaving extracted from the physical layer frame transmitted from the transmission device is returned to be in the original temporal order depending on the offset, the transmission device including the time interleaver that applies the pointer indicating the offset of the start position of the error correction code block included at the start of the data frame when performing the first time interleaving conforming to the first system on the error correction code block conforming to the second system and to be included as the data frame in the physical layer frame.

### BRIEF DESCRIPTION OF DRAWINGS

FIG. 1 is a diagram illustrating an example of a configuration of an embodiment of a transmission system to which the present technology is applied.

FIG. 2 is a diagram schematically illustrating transmission of a broadcast signal by a layered division multiplexing system.

FIG. 3 is a diagram illustrating an example of a signal space of a UL signal and an LL signal.

FIG. 4 is a diagram illustrating an example of transmission specifications of a current system, a next-generation system, and in a period of transition between them.

FIG. 5 is a diagram illustrating an example of applying an FEC block pointer to time deinterleaving.

FIG. 6 is a block diagram illustrating an example of a configuration of a transmission device.

FIG. 7 is a flowchart explaining a flow of transmission processing.

FIG. 8 is a block diagram illustrating a first example of a configuration of a reception device.

FIG. 9 is a flowchart explaining a flow of first reception processing.

FIG. 10 is a block diagram illustrating a second example of the configuration of the reception device.

FIG. 11 is a flowchart explaining a flow of second reception processing.

FIG. 12 is a block diagram illustrating a third example of the configuration of the reception device.

FIG. 13 is a flowchart explaining a flow of third reception processing.

FIG. 14 is a diagram illustrating a configuration example of a computer.

### MODE FOR CARRYING OUT THE INVENTION

Hereinafter, embodiments of the present technology will be described with reference to the drawings. Note that, the description will be given in the following order.

1. Embodiment of the Present Technology

2. Modifications

3. Configuration of Computer

<1. Embodiment of the Present Technology>

(Configuration Example of Transmission System)

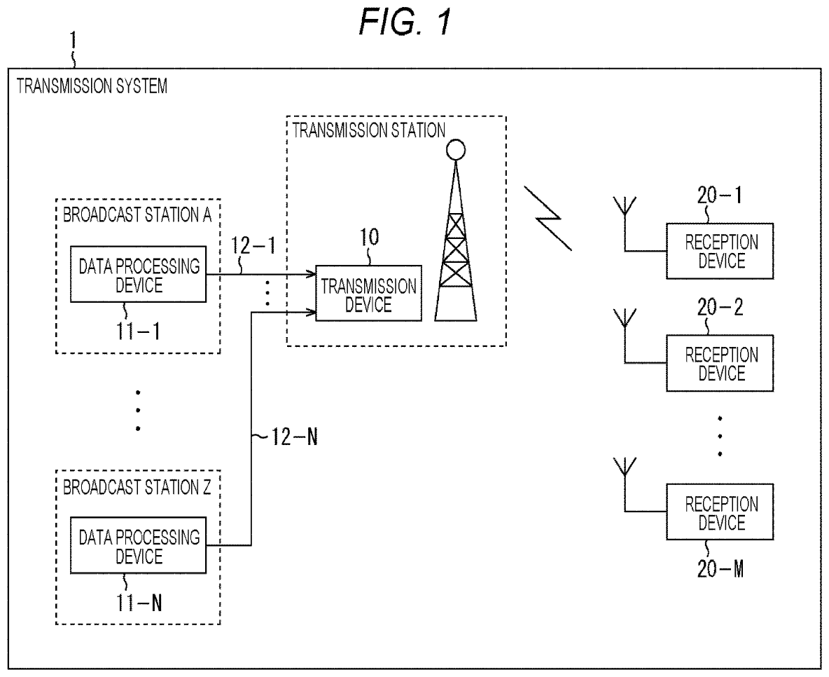

FIG. 1 is a diagram illustrating a configuration of an embodiment of a transmission system to which the present technology is applied. Note that, a system is a logical aggregation of a plurality of devices.

In FIG. 1, a transmission system 1 is a system compatible with a broadcast system such as terrestrial digital television broadcasting. The transmission system 1 includes data processing devices 11-1 to 11-N (N is an integer greater than or equal to 1) installed in facilities related to respective broadcast stations, a transmission device 10 installed in a transmission station, and reception devices 20-1 to 20-M (M is an integer greater than or equal to 1) owned by respective users.

Furthermore, in the transmission system 1, the data processing devices 11-1 to 11-N and the transmission device 10 are connected to each other via communication lines 12-1 to 12-N. Note that, the communication lines 12-1 to 12-N can be dedicated lines, for example.

The data processing device 11-1 performs necessary processing such as encoding on data of a broadcast content (for example, a broadcast program) produced by a broadcast station A, and transmits transmission data obtained as a result to the transmission device 10 via the communication line 12-1.

In the data processing devices 11-2 to 11-N, similarly to the data processing device 11-1, data of broadcast contents produced by respective broadcast stations such as a broadcast station B and a broadcast station Z are processed, and transmission data obtained as a result are transmitted to the transmission device 10 via the communication lines 12-2 to 12-N.

The transmission device 10 receives the transmission data transmitted from the data processing devices 11-1 to 11-N on the broadcast station side via the communication lines 12-1 to 12-N. The transmission device 10 performs necessary processing such as coding and modulation on the transmission data from the data processing devices 11-1 to 11-N, and transmits broadcast signals obtained as a result from an antenna for transmission installed in the transmission station.

As a result, the broadcast signals from the transmission device 10 on the transmission station side are each transmitted to the reception devices 20-1 to 20-M by radio waves in a predetermined frequency band.

The reception devices 20-1 to 20-M are configured as fixed receivers, for example, a television receiver, a Set Top Box (STB), and the like, and are installed at respective user's home or the like.

The reception device 20-1 receives a broadcast signal transmitted from the transmission device 10 by radio waves in a predetermined frequency band and performs necessary processing such as demodulation, decryption, and decoding, thereby reproducing a broadcast content (for example, a broadcast program) depending on a channel selection operation by the user.

In the reception devices 20-2 to 20-M, similarly to the reception device 20-1, the broadcast signals from the transmission device 10 are processed, and a broadcast content is reproduced depending on the channel selection operation by the user.

In this way, in the reception device 20, an image of the broadcast content is displayed on a display, and a sound synchronized with the image is output from a speaker, so that the user can view and listen to the broadcast content such as a broadcast program.

Note that, in the transmission system 1, M reception devices 20 are a mixture of those compatible with the current system and those compatible with the next-generation system. Thus, in the following description, the reception device 20 compatible with the current system is referred to as a current reception device 20L, and the reception device 20 compatible with the next-generation system is referred to as a next-generation reception device 20N, to distinguish them from each other.

Moreover, since the reception device 20 compatible with both the current system and the next-generation system is also assumed, the reception device 20 is referred to as a dual-system reception device 20D in the following description. However, in a case where it is not necessary to distinguish between the current reception device 20L, the next-generation reception device 20N, and the dual-system reception device 20D, it is simply referred to as the reception device 20.

By the way, in Japan, studies are being conducted on the sophistication of terrestrial digital television broadcasting toward the next generation. Here, as one of methods of transitioning from a current broadcast system (current system) to a next-generation broadcast system (next-generation system), it is being studied to introduce a next-generation system having a compatibility by using a current frequency band.

In a period of transition of the broadcast system, a system is assumed in which a broadcast signal of the current system (hereinafter, also referred to as a current broadcast signal) and a broadcast signal of the next-generation system (hereinafter, also referred to as a next-generation broadcast signal) are transmitted by adopting a Layered Division Multiplexing (LDM) system.

That is, in the period of transition of the broadcast system, by using the layered division multiplexing system (LDM system), the current broadcast signal is transmitted in a high power layer as an Upper Layer (UL), and the next-generation broadcast signal is transmitted in a low power layer as a Lower Layer (LL).

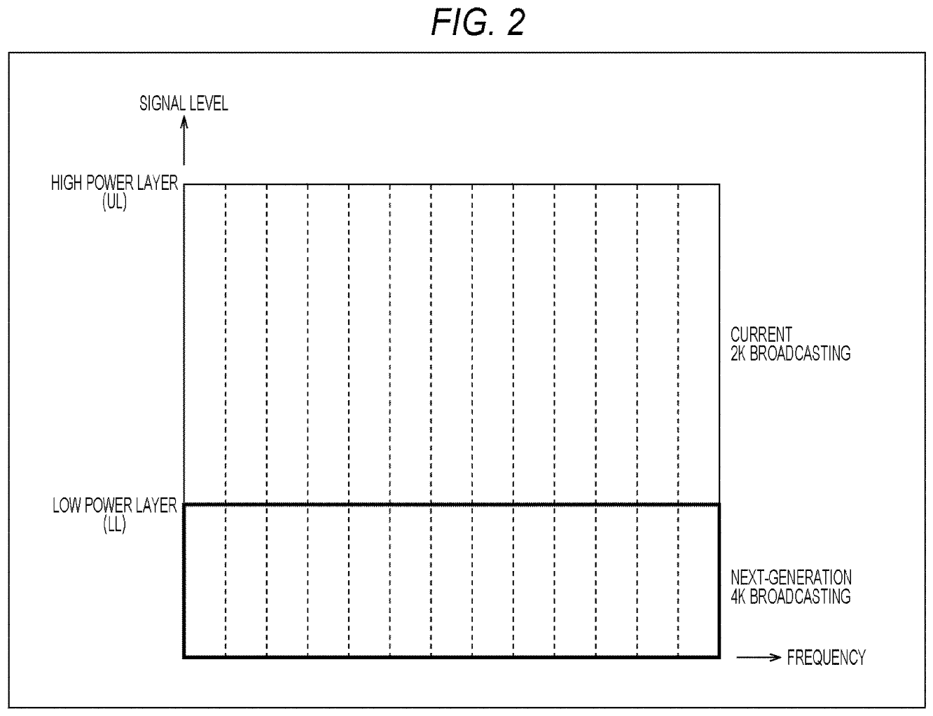

Here, FIG. 2 schematically illustrates transmission of a broadcast signal by the layered division multiplexing system. In FIG. 2, the vertical axis represents a signal level and the horizontal axis represents a frequency.

In FIG. 2, a frequency band of one channel is illustrated, and as illustrated by broken lines in the vertical direction, each frequency band includes a plurality of segments (for example, 13 segments in the case of the current system (ISDB-T system)). Here, the layered division multiplexing system is used, and power of the next-generation broadcast signal is suppressed and multiplexed with the current broadcast signal, whereby it becomes possible to superimpose and transmit the next-generation broadcast signal in the same frequency band as the current broadcast signal.

In FIG. 2, in (a current broadcast signal of) current 2K broadcasting transmitted in the high power layer (UL), a 2K content compatible with a 2K image is transmitted, and in (a next-generation broadcast signal of) next-generation 4K broadcasting transmitted in the low power layer (LL), a 4K content compatible with a 4K image is transmitted, and broadcast signals of 2K and 4K contents can be transmitted on the same channel (frequency band). Note that, for example, the current 2K broadcasting is received by the current reception device 20L, and the next-generation 4K broadcasting is received by the next-generation reception device 20N or the dual-system reception device 20D.

Here, in the reception device 20 compatible with the layered division multiplexing system, a UL signal of the high power layer is first decoded from a broadcast signal transmitted from the transmission device 10, and a transmission point of the UL signal is estimated, and then demapping and decoding of an LL signal in the low power layer are performed by using the estimated transmission point of the UL signal.

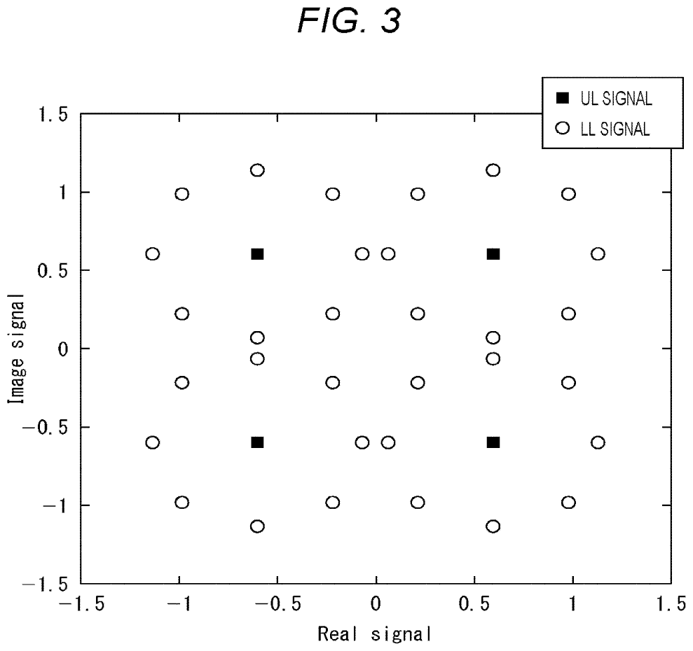

For example, as illustrated in an example of a signal space in FIG. 3, transmission points of the UL signals indicated by black squares in the figure are estimated from the current broadcast signal modulated by Quadrature Phase Shift Keying (QPSK), and demapping and decoding of LL signals indicated by white circles in the figure are performed by using the transmission points of the UL signals. Specifically, in the example of FIG. 3, with each of four UL signal's signal points (black squares in the figure) as the center, eight LL signal's signal points (white circles in the figure) are arranged in a circle.

As described above, since the LL signal is obtained on the basis of the UL signal, in a case where the UL signal and the LL signal have different patterns of time interleaving (time deinterleaving), it becomes necessary for the reception device 20 to perform time interleaving on the UL signal decoding result and further performs time deinterleaving, to perform decoding of the LL signal. For that reason, if the UL signal and the LL signal have different patterns of time interleaving (time deinterleaving), the configuration and processing of the reception device 20 become complicated.

That is, due to that the patterns of time interleaving (time deinterleaving) are different, a dedicated memory (large-scale memory) is necessary that is used only in the period of transition from the current system to the next-generation system and the processing becomes complicated, so that considering the feasibility of the reception device 20, it is essential to make the patterns of time interleaving (time deinterleaving) common between the UL signal and the LL signal.

Thus, in the present technology, time interleaving (time deinterleaving) compatible with the current system is used in the period of transition from the current system to the next-generation system.

Furthermore, in the next-generation system, in a case where a start position of an error correction code block included in (a data frame of) a physical layer frame does not match a start position of (the data frame of) the physical layer frame, a pointer is used indicating an offset of the start position of the error correction code block. By using the pointer, efficient data transmission can be performed even in a case where their start positions do not match.

Specifically, for example, an Orthogonal Frequency Division Multiplexing (OFDM) frame can be used as the physical layer frame, a Forward Error Correction (FEC) block can be used as the error correction block, and an FEC block pointer can be used as the pointer, and in the following, a description will be given taking them as an example.

On the other hand, the current system does not have a function of the pointer, and in a case where the time interleaving (time deinterleaving) compatible with the current system is used in the period of transition, the patterns of the time interleaving (time deinterleaving) are made common between the UL signal and the LL signal, but transmission efficiency of the LL signal corresponding to the next-generation broadcast signal decreases.

For that reason, in the present technology, the time interleaving (time deinterleaving) compatible with the current system is used in the period of transition, and the pointer compatible with the next-generation system is applied to the time interleaving (time deinterleaving), whereby the transmission efficiency is improved.

Note that, after the period of transition, the pointer compatible with the next-generation system is used as it is, so that it is only required to switch the time interleaving (time deinterleaving) from the one compatible with the current system to the one compatible with the next-generation system.

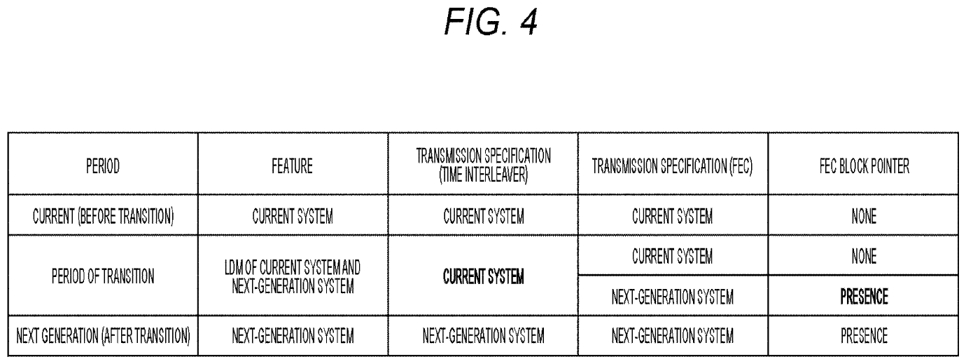

Summarizing the above, a relationship between systems (transmission specifications) applied to the current (before transition), period of transition, and next-generation (after transition) systems is as illustrated in FIG. 4.

That is, before the transition, the current system such as an Integrated Services Digital Broadcasting-Terrestrial (ISDB-T) system is used, so that a time interleaver (time deinterleaver) compatible with the current system and an error correction code (FEC) are used, and the FEC block pointer is not used. That is, since the start position of an FEC block compatible with the current system matches the start position of (a data frame of) the OFDM frame, the FEC block pointer is not required.

In the period of transition, the current broadcast signal of the current system and the next-generation broadcast signal of the next-generation system are transmitted by the layered division multiplexing system (LDM system), but for the purpose of making the patterns of the time interleaving (time deinterleaving) common between the UL signal and the LL signal, the time interleaver (time deinterleaver) compatible with the current system is used as described above.

Furthermore, in the period of transition, the layered division multiplexing system is used, and the UL signal compatible with the current broadcast signal and the LL signal compatible with the next-generation broadcast signal are transmitted, and in the error correction code (FEC) compatible with the current system, there is no need to use the FEC block pointer. On the other hand, in the period of transition, in the error correction code (FEC) compatible with the next-generation system, the FEC block pointer is applied to the time interleaving (time deinterleaving) compatible with the current system as described above.

After the transition, since the next-generation system is used, a time interleaver (time deinterleaver) and the error correction code (FEC) compatible with the next-generation system are used, and further, an FEC block pointer is also used. That is, in the FEC block compatible with the next-generation system, there is a case where its start position does not match the start position of (the data frame of) the OFDM frame, so that the FEC block pointer is used indicating an offset of the start position of the FEC block.

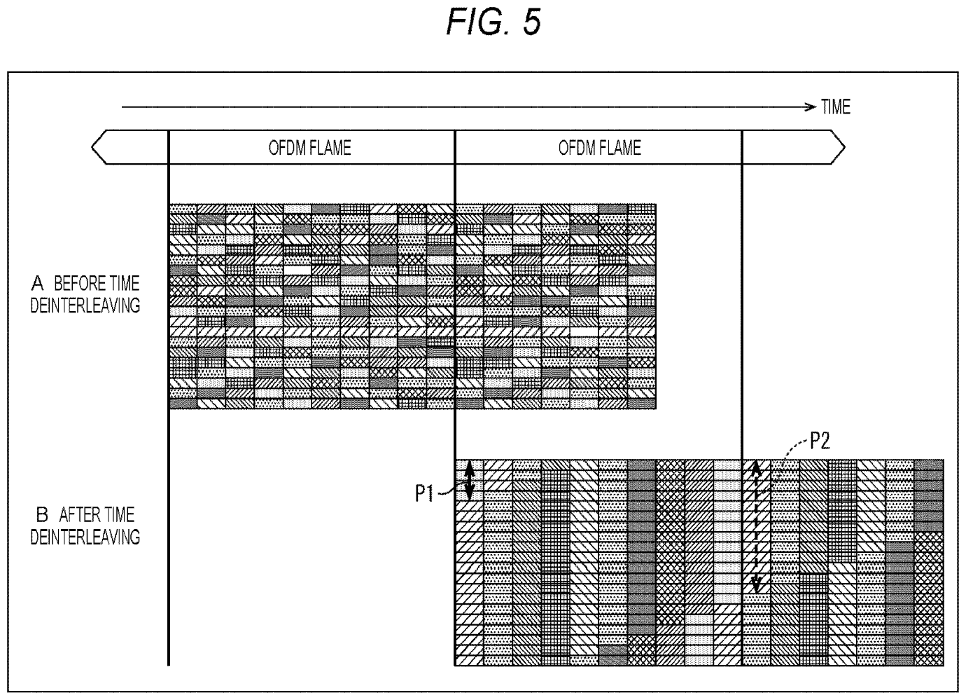

Hereinafter, with reference to FIGS. 5 to 13, detailed description will be given of the present technology in which in the period of transition, the time interleaving (time deinterleaving) compatible with the current system is used and the pointer (FEC block pointer) compatible with the next-generation system is applied to the time interleaving (time deinterleaving).

Note that, in the present disclosure, for the sake of simplification of the explanation, only the current 2K broadcasting will be described as the current system

(ISDB-T system), but in reality, in the current system (ISDB-T system), among the 13 segments, 12 segments are used for broadcasting (current 2K broadcasting) for fixed receivers, and the remaining 1 segment is used for broadcasting (so-called one segment broadcasting) for mobile receivers.

(Example of Time Deinterleaving)

FIG. 5 illustrates an example of applying the FEC block pointer compatible with the next-generation system to the time deinterleaving compatible with the current system in the next-generation reception device 20N or the dual-system reception device 20D. Note that, in FIG. 5, the direction of time is from left to right.

Here, in the dual-system reception device 20D or the like, processing is sequentially performed for a received OFDM frame, and the size of the OFDM frame corresponds to a frame size of the current system such as the ISDB-T system. That is, in the dual-system reception device 20D or the like, the time deinterleaving compatible with the current system is performed in the period of transition, so that the size of the OFDM frame is compatible with the current system.

Furthermore, the OFDM frame includes a transmission control signal together with the data frame. The data frame includes a plurality of FEC blocks. Furthermore, the FEC block has a fixed length, and the fixed length of the FEC block compatible with the next-generation system is longer than that of the FEC block compatible with the current system.

In FIG. 5, in the dual-system reception device 20D or the like, a plurality of FEC blocks that has been subjected to the time interleaving compatible with the current system is extracted for each OFDM frame, and the time deinterleaving compatible with the current system is performed. The FEC block that is a target of the time deinterleaving is an FEC block compatible with the next-generation system.

A of FIG. 5 illustrates the FEC block before the time deinterleaving. In A of FIG. 5, a plurality of FEC blocks is interleaved in the time direction by a predetermined pattern compatible with the current system, and the temporal order is rearranged. Here, each of patterned squares in the figure represents a part of the FEC block, and one FEC block is configured by performing sorting in the original temporal order to collect the squares with the same pattern.

B of FIG. 5 illustrates the FEC block after the time deinterleaving. In B of FIG. 5, the time deinterleaving is performed, whereby each of the plurality of FEC blocks whose temporal order has been rearranged for each OFDM frame is returned to the original temporal order.

At this time, the start position of (the data frame of) the OFDM frame and the start position of the FEC block do not match, but in the dual-system reception device 20D or the like, the start position of the FEC block can be recognized with use of the FEC block pointer. For example, the number of data carriers from the start of the OFDM frame is designated as the offset of the start position of the FEC block, by the FEC block pointer.

Specifically, in the first OFDM frame, the number of data carriers from the start of the OFDM frame is designated as an FEC block pointer P1, and in the second OFDM frame, the number of data carriers from the start of the OFDM frame is designated as an FEC block pointer P2.

Note that, in FIG. 5, the time deinterleaving has been described performed by the next-generation reception device 20N or the dual-system reception device 20D on the reception side, but in the transmission device 10 on the transmission side, the time interleaving corresponding to the time deinterleaving is performed. That is, the transmission device 10 interleaves the plurality of FEC blocks illustrated in B of FIG. 5 in the time direction by rearranging the temporal order in a predetermined pattern compatible with the current system (A of FIG. 5).

As described above, in the period of transition, the time interleaving (time deinterleaving) compatible with the current system is used, and the FEC block pointer used in the FEC block compatible with the next-generation system is applied to the time interleaving (time deinterleaving), whereby the transmission efficiency can be improved.

That is, by applying the FEC block pointer, the reception device 20 can extract the FEC block from the OFDM frame even if the start position of the FEC block included at the start of the OFDM frame does not match the start position of the OFDM frame. In other words, the present technology can be understood as follows. That is, in a case where one FEC block cannot be arranged across (data frames of) a plurality of OFDM frames, for example, it is necessary to perform zero padding or arrange a NULL value on an area where the FEC block cannot be arranged that is at an end portion of the OFDM frame. On the other hand, in the present technology, one FEC block is allowed to be arranged across (the data frames of) the plurality of OFDM frames, so that it is not necessary to arrange, for example, the zero padding or NULL value, and a part of the FEC block can be arranged at the end portion of the OFDM frame, and as a result, a decrease in the transmission efficiency can be suppressed.

(Configuration of Transmission Device)

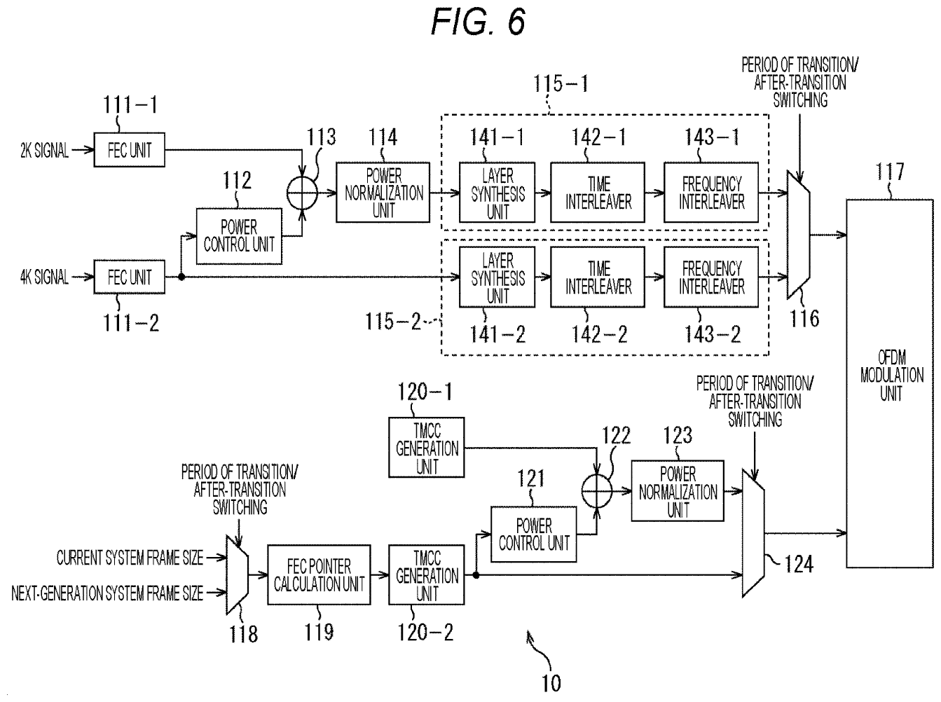

FIG. 6 is a block diagram illustrating an example of a configuration of the transmission device 10 of FIG. 1.

In FIG. 6, the transmission device 10 includes an FEC unit 111-1, an FEC unit 111-2, a power control unit 112, an addition unit 113, a power normalization unit 114, a signal processing unit 115-1, a signal processing unit 115-2, a selector 116, an OFDM modulation unit 117, a selector 118, an FEC pointer calculation unit 119, a TMCC generation unit 120-1, a TMCC generation unit 120-2, a power control unit 121, an addition unit 122, a power normalization unit 123, and a selector 124.

Note that, in FIG. 6, a data signal sequence is configured by the units from the FEC unit 111 to the selector 116, a transmission control signal sequence is configured by the units from the selector 118 to the selector 124, and signals obtained by those sequences are each input to the OFDM modulation unit 117.

First, the data signal sequence illustrated in the upper row will be described.

The FEC unit 111-1 is an FEC coding modulation unit compatible with specifications of the current system. The FEC unit 111-1 performs forward error correction (FEC) on a 2K content signal (2K signal) input as transmission data to the FEC unit 111-1, and supplies a 2K FEC signal obtained as a result to the addition unit 113.

The FEC unit 111-2 is an FEC coding modulation unit compatible with specifications of the next-generation system. The FEC unit 111-2 performs forward error correction (FEC) on a 4K content signal (4K signal) input as transmission data to the FEC unit 111-2, and supplies a 4K FEC signal obtained as a result to the power control unit 112 and the signal processing unit 115-2.

The power control unit 112 performs power control on the 4K FEC signal supplied from the FEC unit 111-2, and supplies a signal (4K FEC signal) obtained as a result to the addition unit 113.

The addition unit 113 adds the 2K FEC signal supplied from the FEC unit 111-1 and the 4K FEC signal supplied from the power control unit 112 together, and supplies an addition signal obtained as a result to the power normalization unit 114. The power normalization unit 114 normalizes power of the addition signal supplied from the addition unit 113 and supplies a normalized signal to the signal processing unit 115-1.

That is, the signal input to the signal processing unit 115-1 is transmitted by the layered division multiplexing system in the period of transition, so that in the power control unit 112, the addition unit 113, and the power normalization unit 114, processing is performed to transmit the 2K content signal (2K FEC signal) in the high power layer (UL) and transmit the 4K content signal (4K FEC signal) in the low power layer (LL).

The signal processing unit 115-1 is a signal processing unit compatible with the specifications of the current system. The signal processing unit 115-1 includes a layer synthesis unit 141-1, a time interleaver 142-1, and a frequency interleaver 143-1.

The layer synthesis unit 141-1 performs processing related to layer synthesis corresponding to the segment, on the signal input to the layer synthesis unit 141-1, and supplies a signal obtained as a result to the time interleaver 142-1.

The time interleaver 142-1 performs time interleaving (interleaving in the time direction) on the signal supplied from the layer synthesis unit 141-1, and supplies a signal after the time interleaving to the frequency interleaver 143-1. Here, the time interleaving performed by the time interleaver 142-1 is the time interleaving corresponding to the time deinterleaving illustrated in FIG. 5.

The frequency interleaver 143-1 performs frequency interleaving (interleaving in the frequency direction) on the signal supplied from the time interleaver 142-1, and supplies a signal after the frequency interleaving to the selector 116.

On the other hand, the signal input to the signal processing unit 115-2 is the 4K content signal (4K FEC signal) transmitted by the next-generation system after the transition. The signal processing unit 115-2 is a signal processing unit compatible with the specifications of the next-generation system. The signal processing unit 115-2 includes a layer synthesis unit 141-2, a time interleaver 142-2, and a frequency interleaver 143-2.

The layer synthesis unit 141-2 performs processing related to layer synthesis. The time interleaver 142-2 performs time interleaving on the signal input to the time interleaver 142-2. The frequency interleaver 143-2 performs frequency interleaving on the signal input to the frequency interleaver 143-2. The signal after the frequency interleaving is supplied to the selector 116.

The selector 116 switches its input to the signal processing unit 115-1 side or the signal processing unit 115-2 side in accordance with a switching signal supplied to the selector 116. The selector 116 selects an LDM-compatible data signal processed by the signal processing unit 115-1 in a case where the switching signal is a signal corresponding to the period of transition, selects a next-generation data signal processed by the signal processing unit 115-2 in a case where the switching signal is a signal corresponding to the after-transition, and outputs each selected data signal to the OFDM modulation unit 117.

Note that, in a case where the operation at that time is the operation corresponding to the period of transition from the current system to the next-generation system, the switching signal is a signal corresponding to the period of transition, and in a case where operation after the transition to the next-generation system is performed, the switching signal is a signal corresponding to the after-transition. For example, notification of the switching signal may be performed from a control circuit (not illustrated) or may be performed from the outside. Note that, the same applies to the switching signal supplied to the other selector in the transmission device 10.

Next, the transmission control signal sequence illustrated in the lower row will be described.

The selector 118 selects the frame size of the current system such as the ISDB-T system in a case where the switching signal supplied to the selector 118 is a signal corresponding to the period of transition, selects the frame size of the next-generation system in a case where the switching signal is a signal corresponding to the after-transition, and supplies each selected frame size to the FEC pointer calculation unit 119.

The FEC pointer calculation unit 119 calculates an FEC block pointer on the basis of the frame size supplied from the selector 118, and supplies the calculated FEC block pointer to the TMCC generation unit 120-2.

Here, for example, on the basis of the frame size of the OFDM frame compatible with the current system or the next-generation system, the number of data carriers from the start of the OFDM frame is obtained as the FEC block pointer indicating the offset of the start position of the FEC block included at the start of (the data frame of) the OFDM frame.

The TMCC generation unit 120-1 generates a Transmission Multiplexing Configuration Control (TMCC) signal (hereinafter, also referred to as a current TMCC signal) as a transmission control signal compatible with the specifications of the current system, and supplies the signal to the addition unit 122. Note that, the TMCC signal is a control signal including information such as a modulation system of each layer and transmission parameters such as an error correction coding rate.

The TMCC generation unit 120-2 generates a TMCC signal (hereinafter, also referred to as a next-generation TMCC signal) as a transmission control signal compatible with the specifications of the next-generation system, and supplies the TMCC signal to the power control unit 121 and the selector 124. The FEC block pointer supplied from the FEC pointer calculation unit 119 is included in the next-generation TMCC signal.

The power control unit 121 performs power control on the signal (next-generation TMCC signal) supplied from the TMCC generation unit 120-2, and supplies a signal obtained as a result to the addition unit 122.

The addition unit 122 adds the signal (current TMCC signal) supplied from the TMCC generation unit 120-1 and the signal (next-generation TMCC signal) supplied from the power control unit 121 together, and supplies an addition signal obtained as a result to the power normalization unit 123. The power normalization unit 123 normalizes power of the addition signal supplied from the addition unit 122 and supplies a normalized signal to the selector 124.

That is, the signal (LDM-compatible transmission control signal) input to the selector 124 is transmitted by the layered division multiplexing system in the period of transition, so that in the power control unit 121, the addition unit 122, and the power normalization unit 123, processing is performed to transmit the transmission control signal (current TMCC signal) compatible with the current system in the high power layer (UL) and transmit the transmission control signal (next-generation TMCC signal) compatible with the next-generation system in the low power layer (LL).

Furthermore, the other signal input to the selector 124, that is, the signal supplied from the TMCC generation unit 120-2 (next-generation transmission control signal) is a transmission control signal (next-generation TMCC signal) compatible with the next-generation system transmitted by the next-generation system after the transition.

The selector 124 selects the LDM-compatible transmission control signal from the power normalization unit 123 in a case where the switching signal supplied to the selector 124 is a signal corresponding to the period of transition, selects the next-generation transmission control signal from the TMCC generation unit 120-2 in a case where the switching signal is a signal corresponding to the after-transition, and outputs each selected transmission control signal to the OFDM modulation unit 117.

Here, in a case where the operation corresponding to the period of transition is performed, to the OFDM modulation unit 117, the LDM-compatible data signal is supplied from the selector 116 on the data signal sequence side, and the LDM-compatible transmission control signal is supplied from the selector 124 on the transmission control signal sequence side.

In this case, the OFDM modulation unit 117 configures (generates) the OFDM frame as the physical layer frame on the basis of the LDM-compatible data signal and the LDM-compatible transmission control signal. Furthermore, the OFDM modulation unit 117 performs processing such as Inverse Fast Fourier Transform (IFFT) and insertion of Guard Interval (GI), on the OFDM frame configuration, and a signal obtained as a result is sent out (transmit) from an antenna for transmission (not illustrated), as a broadcast signal.

As described above, in the period of transition, the layered division multiplexing system is used by the transmission device 10, whereby (the current broadcast signal of) the current 2K broadcasting is transmitted in the high power layer (UL), and (the next-generation broadcast signal of) the next-generation 4K broadcasting is transmitted in the low power layer (LL).

Furthermore, in a case where the operation corresponding to the after-transition is performed, to the OFDM modulation unit 117, the next-generation data signal is supplied from the selector 116 on the data signal sequence side, and the next-generation transmission control signal is supplied from the selector 124 on the transmission control signal sequence side.

In this case, the OFDM modulation unit 117 configures the OFDM frame as the physical layer frame on the basis of the next-generation data signal and the next-generation transmission control signal. Furthermore, the OFDM modulation unit 117 performs processing such as IFFT and insertion of GI, on the OFDM frame configuration, and a signal obtained as a result is sent out from the antenna for transmission (not illustrated), as a broadcast signal.

As described above, after the transition, only (the next-generation broadcast signal of) the next-generation 4K broadcasting after the transition is transmitted by the transmission device 10.

Note that, FIG. 6 illustrates a case where the FEC block pointer is included in the TMCC signal, but this is not a limitation, and the FEC block pointer may be included in other signals. For example, the FEC block pointer may be included in the header of the data frame of the OFDM frame. However, in a case where the FEC block pointer is included in the header, the amount of transmission data is reduced as compared with a case where the FEC block pointer is included in the TMCC signal.

Furthermore, as will be described in detail later, in the TMCC signal, an operation determination signal can be included for notifying the reception device 20 of whether the operation at that time is the operation corresponding to the period of transition or the operation corresponding to the after-transition.

(Flow of Transmission Processing)

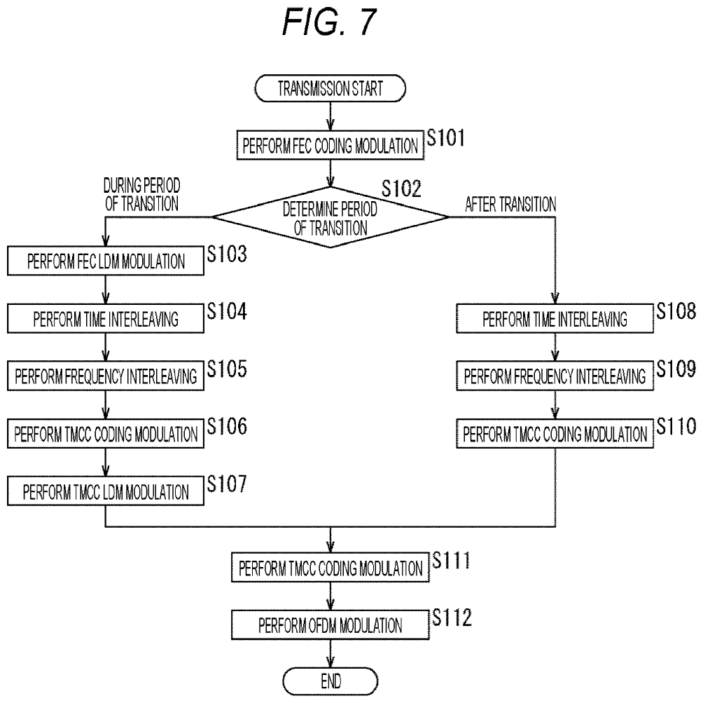

Next, a flow of transmission processing executed by the transmission device 10 of FIG. 6 will be described with reference to a flowchart of FIG. 7.

In step S101, the FEC unit 111-1 and the FEC unit 111-2 perform FEC coding modulation processing. Here, the FEC coding modulation processing on the 2K signal is performed by the FEC unit 111-1. Furthermore, the FEC coding modulation processing on the 4K signal is performed by the FEC unit 111-2.

In determination processing of step S102, it is determined whether or not the operation at that time is the operation during the period of transition or after the transition.

In a case where it is determined in step S102 that the operation at that time is the operation during the period of transition, the processing proceeds to step S103, and the processing of steps S103 to S107, S111, and S112 is executed.

That is, in the power control unit 112, the addition unit 113, and the power normalization unit 114, FEC LDM modulation processing is performed to transmit the 2K FEC signal in the high power layer (UL) and transmit the 4K FEC signal in the low power layer (LL) (S103).

Then, the time interleaver 142-1 performs time interleaving on a signal obtained as a result of the FEC LDM modulation processing (S104). Furthermore, the frequency interleaver 143-1 performs frequency interleaving on a signal after the time interleaving (S105).

Subsequently, the TMCC generation unit 120-1 and the TMCC generation unit 120-2 perform TMCC coding modulation processing (S106). Here, the TMCC coding modulation processing on the current TMCC signal is performed by the TMCC generation unit 120-1. Furthermore, the TMCC coding modulation processing on the next-generation TMCC signal is performed by the TMCC generation unit 120-2.

Furthermore, in the power control unit 121, the addition unit 122, and the power normalization unit 123, TMCC LDM modulation processing is performed to transmit the current TMCC signal in the high power layer (UL) and transmit the next-generation TMCC signal in the low power layer (LL) (S107). Note that, here, the TMCC coding modulation processing is further performed, and the operation determination signal is included indicating that the operation is the one corresponding to the period of transition (S111).

Then, the OFDM modulation unit 117 performs OFDM modulation processing on the basis of the LDM-compatible data signal and the LDM-compatible transmission control signal (S112). A signal obtained as a result of the OFDM modulation processing is sent out as the broadcast signal via the antenna for transmission.

On the other hand, in a case where it is determined in step S102 that the operation at that time is the operation after the transition, the processing proceeds to step S108, and the processing of steps S108 to S112 is executed.

That is, the time interleaver 142-2 performs time interleaving on the 4K FEC signal (S108). Furthermore, the frequency interleaver 143-2 performs frequency interleaving on a signal after the time interleaving (S109).

Subsequently, the TMCC generation unit 120-2 performs the TMCC coding modulation processing on the next-generation TMCC signal (S110). Note that, here, the operation determination signal is included indicating that the operation is the one corresponding to the after-transition (S111).

Then, the OFDM modulation unit 117 performs the OFDM modulation processing on the basis of the next-generation data signal and the next-generation transmission control signal (S112). A signal obtained as a result of the OFDM modulation processing is sent out as the broadcast signal via the antenna for transmission.

The flow of the transmission processing has been described above.

(Configuration of Reception Device)

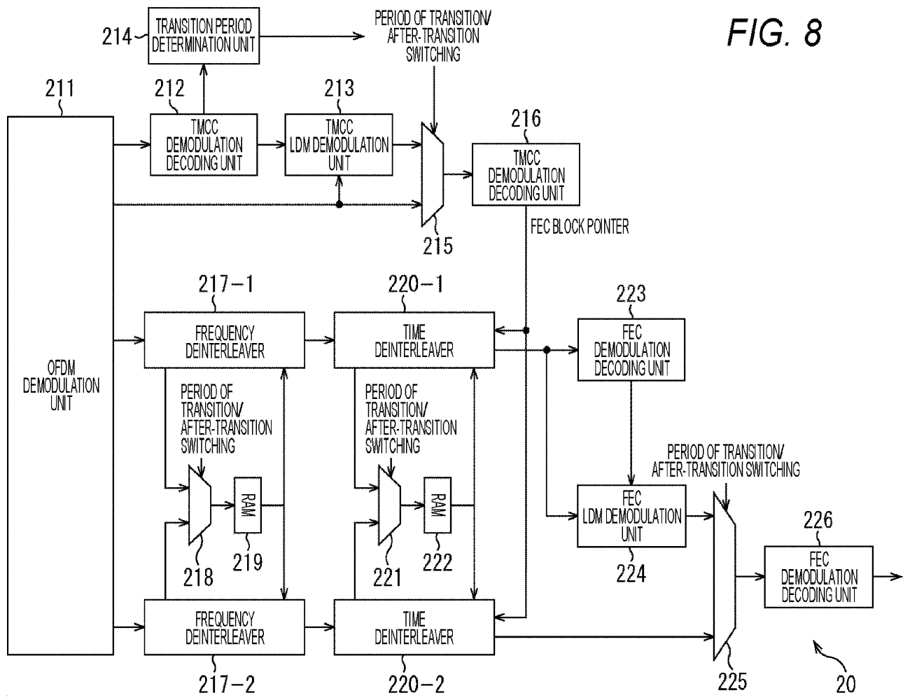

FIG. 8 is a block diagram illustrating a first example of the configuration of the reception device 20 of FIG. 1. Note that, the reception device 20 illustrated in FIG. 8 is configured as, for example, the next-generation reception device 20N or the dual-system reception device 20D.

In FIG. 8, the reception device 20 includes an OFDM demodulation unit 211, a TMCC demodulation decoding unit 212, a TMCC LDM demodulation unit 213, a transition period determination unit 214, a selector 215, a TMCC demodulation decoding unit 216, a frequency deinterleaver 217-1, a frequency deinterleaver 217-2, a selector 218, a RAM 219, a time deinterleaver 220-1, a time deinterleaver 220-2, a selector 221, a RAM 222, an FEC demodulation decoding unit 223, an FEC LDM demodulation unit 224, a selector 225, and an FEC demodulation decoding unit 226.

Note that, in FIG. 8, a transmission control signal sequence is configured by the units from the TMCC demodulation decoding unit 212 to the TMCC demodulation decoding unit 216, a data signal sequence is configured by the units from the frequency deinterleaver 217 to the FEC demodulation decoding unit 226, and signals from the OFDM demodulation unit 211 are input to the sequences, respectively.

A broadcast signal received via an antenna for reception (not illustrated) is input to the OFDM demodulation unit 211. In the OFDM demodulation unit 211, processing such as GI removal, Fast Fourier Transform (FFT), and demodulation of an OFDM frame is performed on the broadcast signal input to the OFDM demodulation unit 211, and a signal obtained as a result is output to the subsequent block.

Here, among signals output from the OFDM demodulation unit 211, an LDM-compatible transmission control signal is supplied to the TMCC demodulation decoding unit 212 and the TMCC LDM demodulation unit 213, and an LDM-compatible data signal is supplied to the frequency deinterleaver 217-1. Furthermore, among the signals output from the OFDM demodulation unit 211, a next-generation transmission control signal is supplied to the selector 215, and a next-generation data signal is supplied to the frequency deinterleaver 217-2.

The TMCC demodulation decoding unit 212 performs demodulation according to a predetermined demodulation system on each carrier in which a TMCC signal is arranged, for the signal (LDM-compatible transmission control signal) supplied from the OFDM demodulation unit 211, and supplies an operation determination signal obtained by decoding a result of the demodulation to the transition period determination unit 214.

The operation determination signal is a signal indicating whether the operation at that time is the operation corresponding to the period of transition or the operation corresponding to the after-transition. Note that, the operation determination signal is represented by, for example, a predetermined bit, and the same bit position can be assigned regardless of during the period of transition or the after-transition.

The transition period determination unit 214 determines whether or not the operation at that time is the operation during the period of transition or after the transition on the basis of the operation determination signal supplied from the TMCC demodulation decoding unit 212, and supplies a switching signal depending on a result of the determination to each of the selector 215, the selector 218, the selector 221, and the selector 225.

Furthermore, the signal from the TMCC demodulation decoding unit 212 is supplied to the TMCC LDM demodulation unit 213. The TMCC LDM demodulation unit 213 performs LDM demodulation on the basis of the signals from the OFDM demodulation unit 211 and the TMCC demodulation decoding unit 212, and supplies a signal depending on a result of the demodulation to the selector 215.

Here, in the period of transition, the layered division multiplexing system is used, a current TMCC signal is transmitted in the high power layer (UL), and a next-generation TMCC signal is transmitted in the low power layer (LL), and demodulation and decoding of the next-generation TMCC signal transmitted in the low power layer (LL) becomes possible by the LDM demodulation.

The signal from the OFDM demodulation unit 211 (next-generation transmission control signal) and the signal from the TMCC LDM demodulation unit 213 are input to the selector 215. The selector 215 selects the signal from the TMCC LDM demodulation unit 213 in a case where the switching signal from the transition period determination unit 214 is a signal corresponding to the period of transition, selects the signal from the OFDM demodulation unit 211 in a case where the switching signal is a signal corresponding to the after-transition, and outputs each selected signal to the TMCC demodulation decoding unit 216.

The TMCC demodulation decoding unit 216 is compatible with the next-generation system, performs demodulation according to a predetermined demodulation system on the signal supplied from the selector 215, and decodes a result of the demodulation to acquire the next-generation TMCC signal. The TMCC demodulation decoding unit 216 supplies an FEC block pointer among parameters included in the acquired next-generation TMCC signal to the time deinterleaver 220-1 and the time deinterleaver 220-2.

The frequency deinterleaver 217-1 is a frequency deinterleaver compatible with the specifications of the current system. On the other hand, the frequency deinterleaver 217-2 is a frequency deinterleaver compatible with the specifications of the next-generation system. The selector 218 and the RAM 219 are provided for the frequency deinterleavers 217-1 and 217-2.

The selector 218 switches its input to the frequency deinterleaver 217-1 side in a case where the switching signal is a signal corresponding to the period of transition, while the selector 218 switches its input to the frequency deinterleaver 217-2 side in a case where the switching signal is a signal corresponding to the after-transition. As a result, the RAM 219 can be used by the frequency deinterleaver 217 compatible with the specifications of the current system or the next-generation system, depending on whether the operation at that time is the operation during the period of transition or after the transition.

The time deinterleaver 220-1 is a time deinterleaver compatible with the specifications of the current system. On the other hand, the time deinterleaver 220-2 is a time deinterleaver compatible with the specifications of the next-generation system. The selector 221 and the RAM 222 are provided for the time deinterleavers 220-1 and 220-2.

The selector 221 switches its input to the time deinterleaver 220-1 side in a case where the switching signal is a signal corresponding to the period of transition, while the selector 221 switches its input to the time deinterleaver 220-2 side in a case where the switching signal is a signal corresponding to the after-transition. As a result, the RAM 222 can be used by the time deinterleaver 220 compatible with the specifications of the current system or the next-generation system, depending on whether the operation at that time is the operation during the period of transition or after the transition.

That is, in the period of transition, the frequency deinterleaver 217-1 performs frequency deinterleaving (deinterleaving in the frequency direction) by appropriately writing/reading the signal (LDM-compatible data signal) supplied from the OFDM demodulation unit 211 to/from the RAM 219, and supplies a signal after the frequency deinterleaving to the time deinterleaver 220-1.

The FEC block pointer is supplied from the TMCC demodulation decoding unit 216 to the time deinterleaver 220-1 together with the signal from the frequency deinterleaver 217-1. The time deinterleaver 220-1 performs time deinterleaving (deinterleaving in the time direction) by appropriately writing/reading the signal after the frequency deinterleaving to/from the RAM 222, and supplies a signal after the time deinterleaving to the FEC demodulation decoding unit 223 and the FEC LDM demodulation unit 224.

Here, the time deinterleaving performed by the time deinterleaver 220-1 corresponds to the time deinterleaving illustrated in FIG. 5. Furthermore, at this time, even in a case where the start position of (a data frame of) the OFDM frame and the start position of the FEC block do not match, the start position of the FEC block is recognized with use of the FEC block pointer, and a plurality of the FEC blocks included in the OFDM frame can be read on a FEC block basis.

The FEC demodulation decoding unit 223 is compatible with the current system, performs demodulation according to a predetermined demodulation system on the signal supplied from the time deinterleaver 220-1, and supplies a signal obtained by decoding a result of the demodulation to the FEC LDM demodulation unit 224.

The FEC LDM demodulation unit 224 performs LDM demodulation on the basis of the signals supplied from the time deinterleaver 220-1 and the FEC demodulation decoding unit 223, and supplies a signal depending on a result of the demodulation to the selector 225.

Here, in the period of transition, the layered division multiplexing system is used, a 2K content signal (2K FEC signal) is transmitted in the high power layer (UL), and a 4K content signal (4K FEC signal) is transmitted in the low power layer (LL), and demodulation and decoding of the 4K FEC signal transmitted in the low power layer (LL) becomes possible by the LDM demodulation.

On the other hand, after the transition, the frequency deinterleaver 217-2 performs frequency deinterleaving by appropriately writing/reading the signal (next-generation data signal) supplied from the OFDM demodulation unit 211 to/from the RAM 219, and supplies a signal after the frequency deinterleaving to the time deinterleaver 220-2.

The FEC block pointer is supplied from the TMCC demodulation decoding unit 216 to the time deinterleaver 220-2 together with the signal from the frequency deinterleaver 217-2. The time deinterleaver 220-2 performs time deinterleaving by appropriately writing/reading the signal after the frequency deinterleaving to/from the RAM 222, and supplies a signal after the time deinterleaving to the selector 225.

Note that, at this time, in the case where the start position of (the data frame of) the OFDM frame and the start position of the FEC block do not match, the start position of the FEC block can be recognized with use of the FEC block pointer.

The signal from the FEC LDM demodulation unit 224 and the signal from the time deinterleaver 220-2 are input to the selector 225. The selector 225 selects the signal from the FEC LDM demodulation unit 224 in a case where the switching signal from the transition period determination unit 214 is a signal corresponding to the period of transition, selects the signal from the time deinterleaver 220-2 in a case where the switching signal is a signal corresponding to the after-transition, and supplies each selected signal to the FEC demodulation decoding unit 226.

That is, in a case where the operation corresponding to the period of transition is performed, the 4K FEC signal obtained from the next-generation broadcast signal transmitted in the low power layer (LL) in the layered division multiplexing system is input to the FEC demodulation decoding unit 226, as the signal from the FEC LDM demodulation unit 224. On the other hand, in a case where the operation corresponding to the after-transition is performed, the 4K FEC signal obtained from the next-generation broadcast signal of the next-generation 4K broadcasting after the transition is input to the FEC demodulation decoding unit 226.

The FEC demodulation decoding unit 226 is compatible with the next-generation system, performs demodulation according to a predetermined demodulation system on the 4K FEC signal supplied from the selector 225, and outputs a 4K signal obtained by decoding a result of the demodulation to a subsequent circuit (for example, a decoder or the like).

As a result, for example, in the next-generation reception device 20N or the dual-system reception device 20D, the 4K signal is processed obtained from the next-generation broadcast signal transmitted in the low power layer (LL) in the layered division multiplexing system, in the period of transition, and the 4K signal is processed obtained from the next-generation broadcast signal of the next-generation 4K broadcasting, after the transition. For that reason, with the next-generation reception device 20N or the dual-system reception device 20D, it is possible to view and listen to 4K contents by the next-generation 4K broadcasting, during the period of transition and after the period of transition.

(Flow of First Reception Processing)

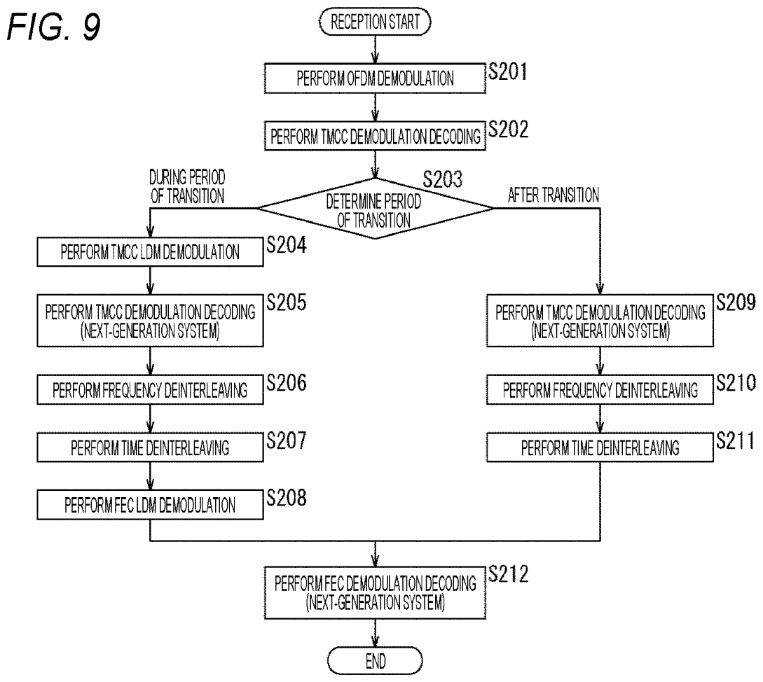

Next, a flow of first reception processing executed by the reception device 20 (the next-generation reception device 20N or the dual-system reception device 20D) of FIG. 8 will be described with reference to a flowchart of FIG. 9.

In step S201, the OFDM demodulation unit 211 performs OFDM demodulation processing on the broadcast signal received via the antenna for reception.

In step S202, the TMCC demodulation decoding unit 212 performs TMCC demodulation decoding processing on the basis of a result of the OFDM demodulation processing. The operation determination signal is detected by the TMCC demodulation decoding processing.

In step S203, the transition period determination unit 214 determines whether or not the operation at that time is the operation during the period of transition or after the transition, on the basis of the detected operation determination signal.

In a case where it is determined in step S203 that the operation at that time is the operation during the period of transition, the processing proceeds to step S204, and the processing of steps S204 to S208 and S212 is executed.

That is, the TMCC demodulation decoding unit 212 performs the TMCC demodulation decoding processing compatible with the current system, and the TMCC LDM demodulation unit 213 performs TMCC LDM demodulation processing (S204), whereby processing is performed on the LL signal of the low power layer with use of the UL signal of the high power layer. As a result, the TMCC demodulation decoding unit 216 performs the TMCC demodulation decoding processing compatible with the next-generation system (S205), whereby the next-generation TMCC signal including the FEC block pointer is obtained.

Then, the frequency deinterleaver 217-1 performs frequency deinterleaving on the signal obtained as a result of the OFDM demodulation processing (S206). Furthermore, the time deinterleaver 220-1 performs time deinterleaving on the signal after the frequency deinterleaving (S207).

Subsequently, the FEC demodulation decoding unit 223 performs FEC demodulation decoding processing compatible with the current system, and the FEC LDM demodulation unit 224 performs FEC LDM demodulation processing (S208), whereby processing is performed on the LL signal of the low power layer with use of the UL signal of the high power layer. As a result, the FEC demodulation decoding unit 226 performs FEC demodulation decoding processing compatible with the next-generation system (S212), whereby the 4K signal is obtained and output to the subsequent circuit.

On the other hand, in a case where it is determined in step S203 that the operation at that time is the operation after the transition, the processing proceeds to step S209, and the processing of steps S209 to S212 is executed.

That is, the TMCC demodulation decoding unit 216 performs the TMCC demodulation decoding processing compatible with the next-generation system on the basis of the result of the OFDM demodulation processing (S209). By the TMCC demodulation decoding processing, the next-generation TMCC signal including the FEC block pointer is obtained.

Then, the frequency deinterleaver 217-2 performs frequency deinterleaving on the signal obtained as a result of the OFDM demodulation processing (S210). Furthermore, the time deinterleaver 220-2 performs time deinterleaving on the signal after the frequency deinterleaving (S211).

Thereafter, the FEC demodulation decoding unit 226 performs the FEC demodulation decoding processing compatible with the next-generation system on the signal after the time deinterleaving (S212), whereby the 4K signal is obtained and output to the subsequent circuit. When the processing of step S212 ends, the first reception processing illustrated in FIG. 9 is ended.

The flow of the first reception processing has been described above.

(Configuration of Reception Device)

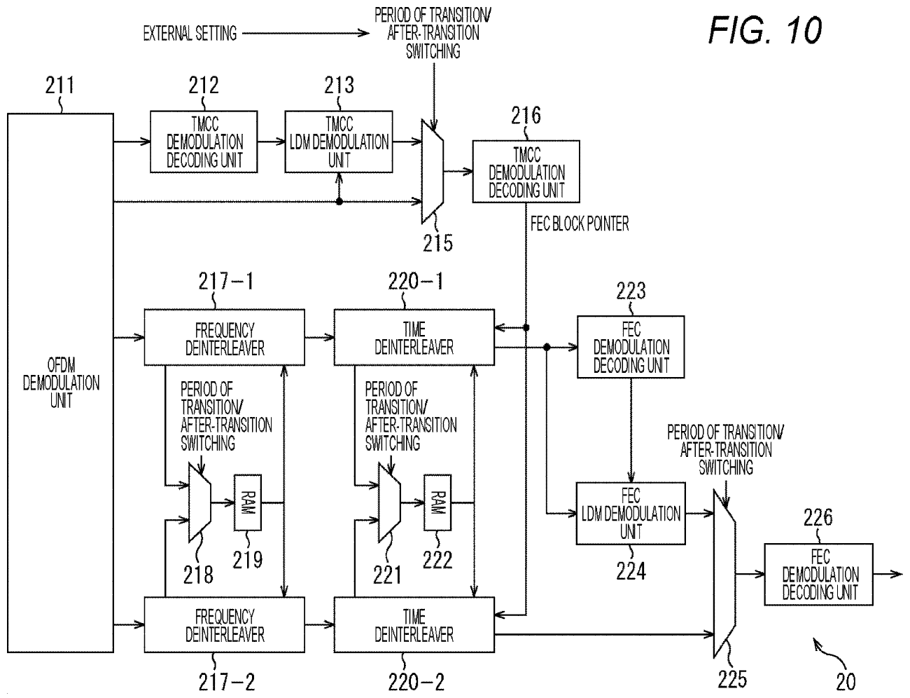

FIG. 10 is a block diagram illustrating a second example of the configuration of the reception device 20 of FIG. 1. Note that, the reception device 20 illustrated in FIG. 10 is configured as, for example, the next-generation reception device 20N or the dual-system reception device 20D.

The second example of the configuration illustrated in FIG. 10 differs in that the transition period determination unit 214 is removed and the switching signal for switching between the period of transition and the after-transition is set from the outside, as compared with the first example of the configuration illustrated in FIG. 8. Here, for example, in a case where the next-generation reception device 20N or the dual-system reception device 20D is a television receiver, the switching signal can be set from the outside of a circuit (demodulation IC) having a demodulation function, such as firmware of a TV set.

Then, in the second example of the configuration illustrated in FIG. 10, the switching signal is supplied to each of the selector 215, the selector 218, the selector 221, and the selector 225, similarly to the first example of the configuration illustrated in FIG. 8, and in each selector, an input signal is selected and output in accordance with the switching signal.

(Flow of Second Reception Processing)

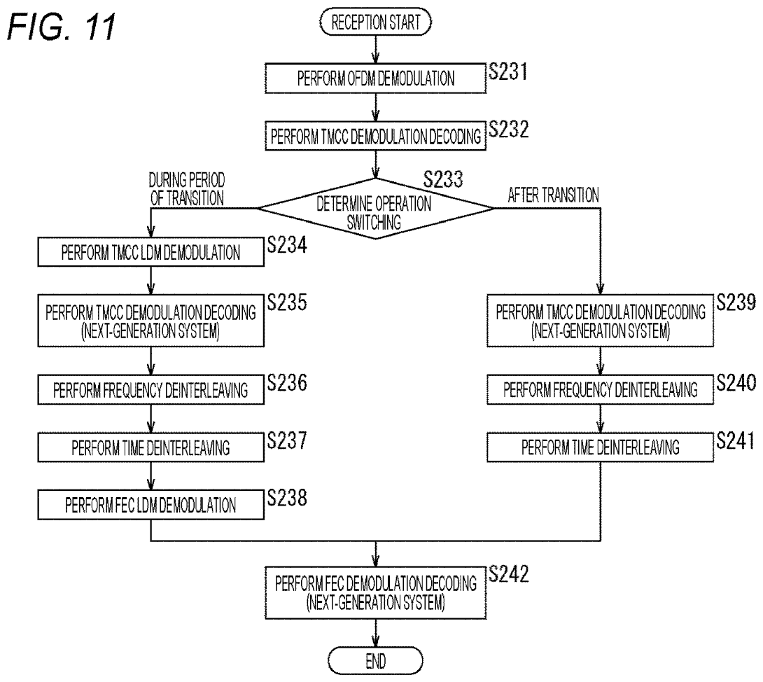

Next, a flow of second reception processing executed by the reception device 20 (the next-generation reception device 20N or the dual-system reception device 20D) of FIG. 10 will be described with reference to a flowchart of FIG. 11.

In the second reception processing illustrated in FIG. 11, determination processing in step S233 is different from the determination processing in step S203 as compared with the first reception processing illustrated in FIG. 9.

In the determination processing of step S233, it is determined whether or not a setting is made to switch the operation on the basis of a setting from the outside such as the firmware of the TV set, that is, whether or not the operation at that time is the operation during the period of transition or after the transition.

In a case where it is determined in step S233 that the operation at that time is the operation during the period of transition, the processing proceeds to step S234, and the processing of steps S234 to S238 and S242 is executed. On the other hand, in a case where it is determined in step S233 that the operation at that time is the operation after the transition, the processing proceeds to step S239, and the processing of steps S239 to S242 is executed.

Note that, the processing other than step S233, that is, the processing of steps S231, S232, and S234 to S242 in FIG. 11 is similar to the processing of steps S201, S202, and S204 to S212 in FIG. 9.

The flow of the second reception processing has been described above.

(Configuration of Reception Device)

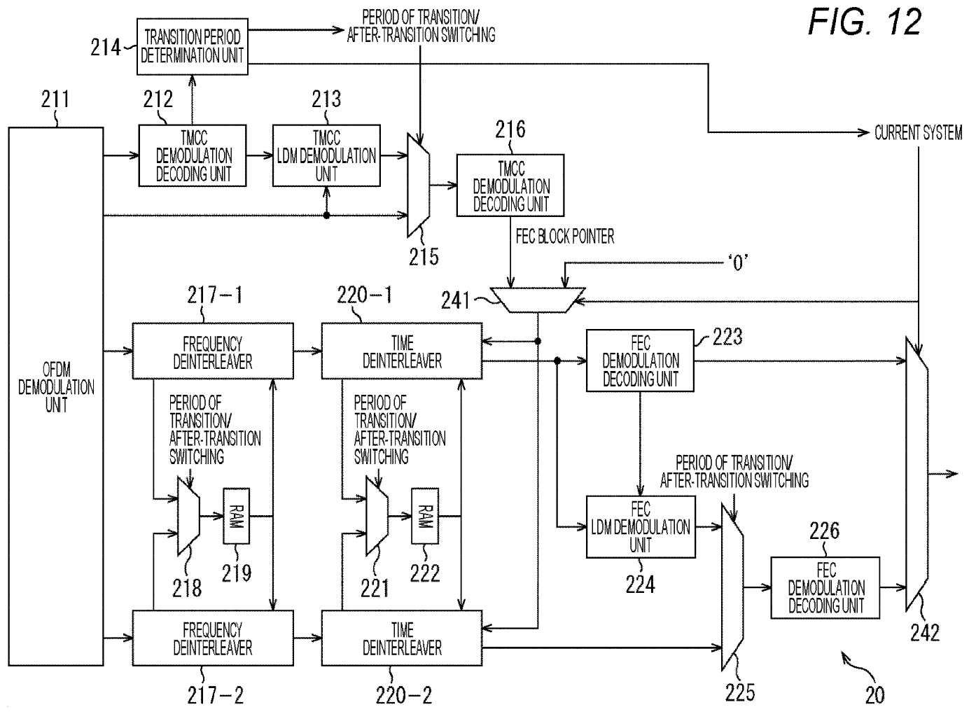

FIG. 12 is a block diagram illustrating a third example of the configuration of the reception device 20 of FIG. 1. Note that, the reception device 20 illustrated in FIG. 10 is configured as a dual-system reception device 20D.

The third example of the configuration illustrated in FIG. 12 differs in that a selector 241 and a selector 242 are added and is configured to be capable of selecting the signal corresponding to the current system, as compared with the first example of the configuration illustrated in FIG. 8.

Here, for example, the transition period determination unit 214 determines whether or not the operation at that time is the operation of the current system (before the transition) on the basis of a signal supplied from the TMCC demodulation decoding unit 212 (for example, an operation determination signal), and supplies a switching signal depending on a result of the determination to the selector 241 and the selector 242.

In a case where the switching signal from the transition period determination unit 214 is a signal corresponding to the current system (before the transition), the selector 241 selects ‘0’ and supplies ‘0’ to the time deinterleaver 220-1. That is, the start position of the FEC block compatible with the current system matches the start position of the OFDM frame (data frame), and the FEC block pointer is unnecessary, so that ‘0’ is input here.

Furthermore, the selector 241 selects a signal (FEC block pointer) from the TMCC demodulation decoding unit 216 in a case where the switching signal from the transition period determination unit 214 is not a signal corresponding to the current system (before the transition) (in a case where the switching signal is the signal corresponding to the period of transition or the after-transition), and supplies the selected signal to the time deinterleaver 220-1 or the time deinterleaver 220-2.

In the case where the switching signal from the transition period determination unit 214 is the signal corresponding to the current system (before the transition), the selector 242 selects a signal (2K signal) from the FEC demodulation decoding unit 223 compatible with the current system, and outputs the signal to a subsequent circuit (for example, decoder or the like). As a result, with the dual-system reception device 20D, it is possible to view and listen to 2K contents by the current 2K broadcasting.

Furthermore, in the case where the switching signal from the transition period determination unit 214 is not the signal corresponding to the current system (before the transition) (in the case where the switching signal is the signal corresponding to the period of transition or the after-transition), the selector 242 selects a signal (4K signal) from the FEC demodulation decoding unit 226 compatible with the next-generation system, and outputs the signal to the subsequent circuit. As a result, with the dual-system reception device 20D, it is possible to view and listen to 4K contents by the next-generation 4K broadcasting.

(Flow of Third Reception Processing)

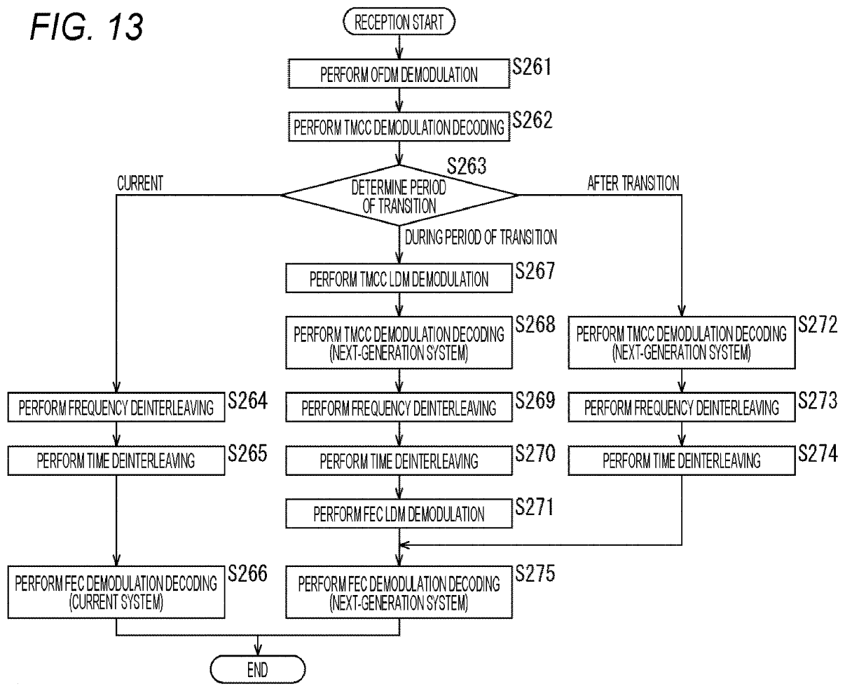

Next, a flow of third reception processing executed by the reception device 20 (dual-system reception device 20D) of FIG. 12 will be described with reference to a flowchart of FIG. 13.

In the third reception processing illustrated in FIG. 13, determination processing in step S263 is different from the determination processing in step S203 as compared with the first reception processing illustrated in FIG. 9.

In the determination processing of step S263, it is determined whether or not the operation at that time is the operation in the current system (before the transition) in addition to whether or not the operation at that time is the operation during the period of transition or after the transition.

In a case where it is determined in step S263 that the operation at that time is the operation in the current system (before the transition), the processing proceeds to step S264, and the processing of steps S264 to S266 is executed.

That is, the frequency deinterleaver 217-1 performs frequency deinterleaving on the signal (current data signal) obtained as a result of the OFDM demodulation processing (S264). Furthermore, the time deinterleaver 220-1 performs time deinterleaving on the signal after the frequency deinterleaving (S265).

Then, the FEC demodulation decoding unit 223 performs FEC demodulation decoding processing compatible with the current system (S266), whereby a 2K signal is obtained from a 2K FEC signal and is output to the subsequent circuit.

Note that, in a case where it is determined in step S263 that the operation at that time is the operation during the period of transition, the processing proceeds to step S267, and the processing of steps S267 to S271 and S275 is executed, and the processing of these steps is similar to the processing of steps S204 to S208 and S212 of FIG. 9.

Furthermore, in a case where it is determined in step S263 that the operation at that time is the operation after the transition, the processing proceeds to step S272, and the processing of steps S272 to S275 is executed, and the processing of these steps is similar to the processing of steps S209 to S212 of FIG. 9.

The flow of the third reception processing has been described above.

Note that, in the third example of the configuration illustrated in FIG. 12, a configuration has been described in which the transition period determination unit 214 determines whether or not the operation at that time is the operation in the current system (before the transition) on the basis of the signal supplied from the TMCC demodulation decoding unit 212, and outputs the switching signal depending on the result of the determination; however, the switching signal may be set from the outside similarly to the second example of the configuration illustrated in FIG. 10. Specifically, a switching signal indicating the current system (before the transition) may be set for the selectors 241 and 242 by, for example, the firmware of the TV set, or the like.

Furthermore, in the third reception processing illustrated in FIG. 13, an example has been described in which the next-generation 4K broadcasting is received by the dual-system reception device 20D in the period of transition; however, the current 2K broadcasting may be received.

<2. Modifications>

(Examples of Other Broadcast Systems)

In the above description, the ISDB-T system has been described as a broadcast system for terrestrial digital television broadcasting, but the present technology may be applied to other broadcast systems. Furthermore, not limited to the ground wave (terrestrial broadcasting), the present technology may be applied to broadcast systems, for example, satellite broadcasting using a Broadcasting Satellite (BS) and a Communications Satellite (CS), or cable broadcasting using cables (Common Antenna TeleVision (CATV)).

(Other Configurations of Reception Device)

Furthermore, in the above description, the reception device 20 (FIG. 1) has been described as being configured as a fixed receiver such as a television receiver or a set top box (STB), but the fixed receiver may include electronic devices, for example, a recorder, game machine, personal computer, network storage, and the like. Moreover, the reception device 20 (FIG. 1) is not limited to the fixed receiver, and may include electronic devices, for example, a mobile receiver such as a smartphone, a mobile phone, or a tablet computer, an in-vehicle device mounted on a vehicle such as an in-vehicle television, a wearable computer such as a Head Mounted Display (HMD), and the like.

Furthermore, the transmission device 10 having the configuration illustrated in FIG. 6 may be regarded as a modulation device or a modulation unit (for example, a modulation circuit). Similarly, the reception device 20 having the configuration illustrated in FIG. 8 or the like may be regarded as a demodulation device or a demodulation unit (for example, a demodulation circuit or a demodulation IC). Moreover, in the transmission device 10 illustrated in FIG. 6, the OFDM modulation unit 117 may be regarded as a transmission unit that transmits a broadcast signal via an antenna for transmission. Similarly, in the reception device 20 having the configuration illustrated in FIG. 8 or the like, the OFDM demodulation unit 211 may be regarded as a reception unit that receives a broadcast signal via an antenna for reception.

(Configuration Including Communication Line)

Furthermore, in the transmission system 1 (FIG. 1), although not illustrated, various servers may be connected to a communication line such as the Internet, and the reception device 20 (FIG. 1) having a communication function may be enabled to receive various data such as contents and applications by accessing the various servers and performing bidirectional communication via the communication line such as the Internet.

(Others)

Note that, the terms used in the present disclosure are examples, and use of other terms is not intentionally excluded. For example, in the above description, the frame may be replaced by another term such a packet.

Furthermore, in the present disclosure, the “2K image” is an image compatible with a screen resolution of about 1920×1080 pixels, and the “4K image” is an image compatible with a screen resolution of about 3840×2160 pixels. Furthermore, in the above description, as broadcast contents, the 2K content of the 2K image transmitted by the current 2K broadcasting (current system) and the 4K content of the 4K image transmitted by the next-generation 4K broadcasting (next-generation system) have been described; however, a broadcast content transmitted by the next-generation system may be higher image quality content such as an 8K image. However, “8K image” is an image compatible with a screen resolution of about 7680×4320 pixels.

<3. Configuration of Computer>

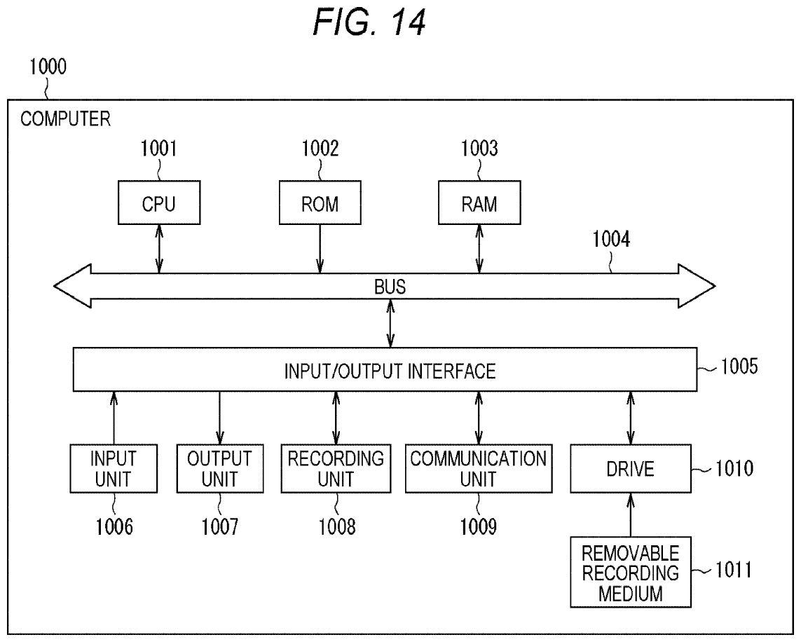

A series of processing steps described above can be executed by hardware, or can be executed by software. In a case where the series of processing steps is executed by software, a program constituting the software is installed in a computer. FIG. 14 is a diagram illustrating a configuration example of hardware of the computer that executes the series of processing steps described above by the program.

In a computer 1000, a central processing unit (CPU) 1001, a read only memory (ROM) 1002, and a random access memory (RAM) 1003 are connected to each other by a bus 1004. Moreover, an input/output interface 1005 is connected to the bus 1004. The input/output interface 1005 is connected to an input unit 1006, an output unit 1007, a recording unit 1008, a communication unit 1009, and a drive 1010.

The input unit 1006 includes a keyboard, a mouse, a microphone, and the like. The output unit 1007 includes a display, a speaker, and the like. The recording unit 1008 includes a hard disk, a nonvolatile memory, or the like. The communication unit 1009 includes a network interface and the like. The drive 1010 drives a removable recording medium 1011 such as a magnetic disk, an optical disk, a magneto-optical disk, or a semiconductor memory.

In the computer 1000 configured as described above, the CPU 1001 loads and executes the program recorded in the ROM 1002 or the recording unit 1008 to the RAM 1003 via the input/output interface 1005 and the bus 1004, whereby the series of processing steps described above is performed.

The program executed by the computer 1000 (CPU 1001) can be provided, for example, by being recorded in the removable recording medium 1011 as a package medium or the like. Furthermore, the program can be provided via a wired or wireless transmission medium such as a local area network, the Internet, or digital satellite broadcasting.

In the computer 1000, the program can be installed to the recording unit 1008 via the input/output interface 1005 by mounting the removable recording medium 1011 to the drive 1010. Furthermore, the program can be installed to the recording unit 1008 by receiving with the communication unit 1009 via the wired or wireless transmission medium. In addition, the program can be installed in advance to the ROM 1002 or the recording unit 1008.

Here, in the present disclosure, the processing performed by the computer in accordance with the program does not necessarily have to be performed chronologically in the order described as the flowchart. In other words, the processing performed by the computer in accordance with the program also includes processing executed in parallel or individually (for example, parallel processing or processing by an object). Furthermore, the program may be processed by one computer (processor) or may be distributed and processed by a plurality of computers.

Note that, the embodiment of the present technology is not limited to the embodiments described above, and various modifications are possible without departing from the scope of the present technology.

Furthermore, the present technology can have a configuration as follows.

(1)

A transmission device including

a first time interleaver that performs first time interleaving conforming to a first system, on an error correction code block to be included as a data frame in a physical layer frame, in which

the error correction code block conforms to a second system, and

when performing the first time interleaving, the first time interleaver applies a pointer indicating an offset of a start position of the error correction code block included at a start of the data frame.

(2)

The transmission device according to (1), further including

a transmission unit that transmits the physical layer frame as a broadcast signal to which a layered division multiplexing system is applied.

(3)

The transmission device according to (2), in which

the transmission unit transmits the physical layer frame including the data frame and a transmission control signal, and

the pointer is included in the transmission control signal.

(4)

The transmission device according to (2) or (3), in which

the second system includes a next-generation system of the first system, and

the first time interleaver performs the first time interleaving during a period of transition between the first system and the second system.

(5)

The transmission device according to (4), further including

a second time interleaver that performs second time interleaving conforming to the second system, in which

the second time interleaver performs the second time interleaving after transition to the second system.

(6)

The transmission device according to (5), in which

switching from the first time interleaver to the second time interleaver is performed on the basis of a switching signal indicating whether or not it is the period of transition.

(7)

The transmission device according to (6), in which

the transmission unit transmits the physical layer frame including the data frame and a transmission control signal, and

the switching signal is included in the transmission control signal.

(8)

The transmission device according to (4), in which

the first system includes an ISDB-T system, and

the second system includes a next-generation system of the ISDB-T system.

(9)

The transmission device according to any of (1) to (8), in which

the physical layer frame includes an OFDM frame,

the error correction code block includes an FEC block, and

the pointer includes an FEC block pointer.

(10)

A transmission method in which

a transmission device,

when performing time interleaving conforming to a first system on an error correction code block conforming to a second system and to be included as a data frame in a physical layer frame, applies a pointer indicating an offset of a start position of the error correction code block included at a start of the data frame.

(11)

A reception device including

a first time deinterleaver that performs first time deinterleaving in which an error correction code block after first time interleaving extracted from a physical layer frame transmitted from a transmission device is returned to be in original temporal order depending on an offset,

the transmission device including a time interleaver that applies a pointer indicating the offset of a start position of the error correction code block included at a start of a data frame when performing the first time interleaving conforming to a first system on the error correction code block conforming to a second system and to be included as a data frame in the physical layer frame.

(12)

The reception device according to (11), further including

a reception unit that receives the physical layer frame transmitted as a broadcast signal to which a layered division multiplexing system is applied.

(13)

The reception device according to (12), in which

the reception unit receives the physical layer frame including the data frame and a transmission control signal, and

the pointer is included in the transmission control signal.

(14)

The reception device according to (12) or (13), in which

the second system includes a next-generation system of the first system, and

the first time deinterleaver performs the first time deinterleaving during a period of transition between the first system and the second system.

(15)

The reception device according to (14), further including

a second time deinterleaver that performs second time deinterleaving conforming to the second system, and

the second time deinterleaver performs the second time deinterleaving after transition to the second system.

(16)

The reception device according to (15), in which

switching from the first time deinterleaver to the second time deinterleaver is performed on the basis of a switching signal indicating whether or not it is the period of transition.

(17)

The reception device according to (16), in which

the reception unit receives the physical layer frame including the data frame and a transmission control signal, and

the switching signal is included in the transmission control signal or is externally set.

(18)

The reception device according to (14), in which

the first system includes an ISDB-T system, and

the second system includes a next-generation system of the ISDB-T system.

(19)

The reception device according to any of (11) to (18), in which

the physical layer frame includes an OFDM frame,

the error correction code block includes an FEC block, and

the pointer includes an FEC block pointer.

(20)

A reception method in which

a reception device performs time deinterleaving in which an error correction code block after time interleaving extracted from a physical layer frame is returned to be in original temporal order depending on an offset,

the reception device receiving the physical layer frame transmitted from a transmission device including a time interleaver that applies a pointer indicating the offset of a start position of the error correction code block included at a start of a data frame when performing the time interleaving conforming to a first system on the error correction code block conforming to a second system and to be included as a data frame in the physical layer frame.

### REFERENCE SIGNS LIST

1 Transmission system
10 Transmission device
11, 11-1 to 11-N Data processing device
20, 20-1 to 20-M Reception device
20D Dual-system reception device
20L Current reception device
20N Next-generation reception device
111-1, 111-2 FEC unit
112 Power control unit
113 Addition unit
114 Power normalization unit
115-1, 115-2 Signal processing unit

### 116 Selector

117 OFDM modulation unit

### 118 Selector

119 FEC pointer calculation unit
120-1, 120-2 TMCC generation unit
121 Power control unit
122 Addition unit
123 Power normalization unit

### 124 Selector

141-1, 141-2 Layer synthesis unit
142-1, 142-2 Time interleaver
143-1, 143-2 Frequency interleaver
211 OFDM demodulation unit
212 TMCC demodulation decoding unit
213 TMCC LDM demodulation unit
214 Transition period determination unit

### 215 Selector

216 TMCC demodulation decoding unit
217-1, 217-2 Frequency deinterleaver

### 218 Selector

### 219 RAM

220-1, 220-2 Time deinterleaver

### 221 Selector

### 222 RAM

223 FEC demodulation decoding unit
224 FEC LDM demodulation unit

### 225 Selector

226 FEC Demodulation decoding unit

### 241 Selector

### 242 Selector

### 1000 Computer

### 1001 CPU

1. A transmission device comprising
a first time interleaver that performs first time interleaving conforming to a first system, on an error correction code block to be included as a data frame in a physical layer frame, wherein
the error correction code block conforms to a second system, and
when performing the first time interleaving, the first time interleaver applies a pointer indicating an offset of a start position of the error correction code block included at a start of the data frame.

2. The transmission device according to claim 1, further comprising
a transmission unit that transmits the physical layer frame as a broadcast signal to which a layered division multiplexing system is applied.

3. The transmission device according to claim 2, wherein
the transmission unit transmits the physical layer frame including the data frame and a transmission control signal, and
the pointer is included in the transmission control signal.

4. The transmission device according to claim 2, wherein
the second system includes a next-generation system of the first system, and
the first time interleaver performs the first time interleaving during a period of transition between the first system and the second system.

5. The transmission device according to claim 4, further comprising
a second time interleaver that performs second time interleaving conforming to the second system, wherein
the second time interleaver performs the second time interleaving after transition to the second system.

6. The transmission device according to claim 5, wherein
switching from the first time interleaver to the second time interleaver is performed on a basis of a switching signal indicating whether or not it is the period of transition.

7. The transmission device according to claim 6, wherein
the transmission unit transmits the physical layer frame including the data frame and a transmission control signal, and
the switching signal is included in the transmission control signal.

8. The transmission device according to claim 4, wherein
the first system includes an ISDB-T system, and
the second system includes a next-generation system of the ISDB-T system.

9. The transmission device according to claim 8, wherein
the physical layer frame includes an OFDM frame,
the error correction code block includes an FEC block, and
the pointer includes an FEC block pointer.

10. A transmission method in which
a transmission device,
when performing time interleaving conforming to a first system on an error correction code block conforming to a second system and to be included as a data frame in a physical layer frame, applies a pointer indicating an offset of a start position of the error correction code block included at a start of the data frame.

11. A reception device comprising
a first time deinterleaver that performs first time deinterleaving in which an error correction code block after first time interleaving extracted from a physical layer frame transmitted from a transmission device is returned to be in original temporal order depending on an offset,
the transmission device including a time interleaver that applies a pointer indicating the offset of a start position of the error correction code block included at a start of a data frame when performing the first time interleaving conforming to a first system on the error correction code block conforming to a second system and to be included as a data frame in the physical layer frame.

12. The reception device according to claim 11, further comprising
a reception unit that receives the physical layer frame transmitted as a broadcast signal to which a layered division multiplexing system is applied.

13. The reception device according to claim 12, wherein
the reception unit receives the physical layer frame including the data frame and a transmission control signal, and
the pointer is included in the transmission control signal.

14. The reception device according to claim 12, wherein
the second system includes a next-generation system of the first system, and
the first time deinterleaver performs the first time deinterleaving during a period of transition between the first system and the second system.

15. The reception device according to claim 14, further comprising
a second time deinterleaver that performs second time deinterleaving conforming to the second system, and
the second time deinterleaver performs the second time deinterleaving after transition to the second system.

16. The reception device according to claim 15, wherein
switching from the first time deinterleaver to the second time deinterleaver is performed on a basis of a switching signal indicating whether or not it is the period of transition.

17. The reception device according to claim 16, wherein
the reception unit receives the physical layer frame including the data frame and a transmission control signal, and
the switching signal is included in the transmission control signal or is externally set.

18. The reception device according to claim 14, wherein
the first system includes an ISDB-T system, and
the second system includes a next-generation system of the ISDB-T system.

19. The reception device according to claim 18, wherein
the physical layer frame includes an OFDM frame,
the error correction code block includes an FEC block, and
the pointer includes an FEC block pointer.

20. A reception method in which
a reception device performs time deinterleaving in which an error correction code block after time interleaving extracted from a physical layer frame is returned to be in original temporal order depending on an offset,
the reception device receiving the physical layer frame transmitted from a transmission device including a time interleaver that applies a pointer indicating the offset of a start position of the error correction code block included at a start of a data frame when performing the time interleaving conforming to a first system on the error correction code block conforming to a second system and to be included as a data frame in the physical layer frame.
